(19) United States
(12) Patent Application Publication
(10) Pub. No.: US 2009/0235162 A1
(43) Pub. Date: Sep. 17, 2009

(54) Method and system for providing enhanced virtual books

(75) Inventors: Adam Nuccio, Victorville, CA (US); Bryan Martinez, Burbank, CA (US); Robyn Tynan-Winters, Moorpark, CA (US); Marianne Nebel, New York, NY (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC., BURBANK, CA (US)

(21) Appl. No.: 12/075,501

(22) Filed: Mar. 11, 2008

(51) Int. Cl. G06F 3/048; G06F 17/00; G06F 15/16

(52) U.S. Cl. 715/255; 709/203; 715/810

(57) ABSTRACT

There is provided a method of providing virtual books, comprising identifying an electronic book for conversion to a virtual book, designating graphical assets for inclusion in the virtual book, translating the electronic book into a dynamic rich media format, determining a plurality of pronunciations by associating words in the translated virtual book with their respective entries in a vocal library, assigning a plurality of definitions by associating words in the translated virtual book with their respective entries in a dictionary, and integrating the graphical assets, the pronunciations, and the definitions with the translated virtual book. In one embodiment, a system for providing virtual books includes a virtual book interaction software supported as a web application providing access to virtual books. In one embodiment, a plurality of virtual books may be stored as high-definition rich media segments on a computer readable medium.

### BACKGROUND OF THE INVENTION

1. Field of the Invention

The present invention relates generally to the production of information content. More particularly, the present invention relates to the production of computer mediated interactive information content.

2. Background Art

The convenience and immediacy of modem electronic based information technologies are seductive, and have increasingly lured attention from print media, and especially books, which require more of our scarce time and attention to absorb. To the extent that electronic alternatives to the type of information previously available only in print enables us to acquire more information more efficiently, those advances represent a benefit to all, both as individuals and as a society. However, as we collectively turn with increasing frequency away from books and towards their electronic substitutes, we become estranged from an approach to knowledge and learning that has played a major role in shaping the foundations of our culture.

For those of us old enough to have developed a relationship with books, of necessity, in the natural course of coming into adulthood, books may provide an easy intimacy with the written word, not readily replaced by electronic information content, despite its utility. Such may not be the case for the young, however, for whom educational content, entertainment content, and even the means and mechanisms of literary communication are increasingly electronically based. To many of today's technologically proficient children and young adults, books may be unfamiliar or even relatively unknown. This is an undesirable state of affairs, however, because the relationship between books and human beings is special and symbolic, and transcends the sterile bounds of the data embodied within bookish bindings. To lose touch with books is to lose touch with a portion of ourselves. It is also to forget how we came to arrive at this present intellectually flourishing point in our civilization.

Today, books are being gradually supplanted by electronic information content for numerous valid and progressive reasons. For example, electronic information content enables great storage and distribution efficiencies, which are not likely to be sacrificed for the sake of nostalgia or tradition, nor should they be. In addition, growing awareness of the fragility of the Earth's ecosystem, and the toll taken by our collective endeavors on the limited sustainable resources available for harvesting, militate for approaches to information storage and communication that minimizes that environmental cost. However, conventional approaches to meeting the ever increasing need for speedy information exchange while also minimizing the use of consumables in managing and distributing that information fails to acknowledge the iconic status of books as both a literal and a literary manifestation of our culture's search for meaning and identity.

Accordingly, there is a need to overcome the drawbacks and deficiencies in the art by providing an information content option that allows users to discover or reconnect with the experience of enjoying books, while concurrently delivering the efficiencies and advantages of electronic documents.

### SUMMARY OF THE INVENTION

There are provided methods and systems for providing enhanced virtual books, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an exemplary system for providing enhanced virtual books, according to one embodiment of the present invention;

FIG. 2 shows a more detailed exemplary embodiment of a system for providing enhanced virtual books, according to one embodiment of the present invention;

FIG. 3 is a flowchart presenting a method of providing enhanced virtual books, according to one embodiment of the present invention;

FIG. 4 shows a diagram of an exemplary system for providing enhanced virtual books stored on a computer readable medium, according to one embodiment of the present invention;

FIG. 5 is a flowchart presenting a method of providing enhanced virtual books stored on a computer readable medium, according to one embodiment of the present invention; and

FIG. 6 shows a visual frame of an exemplary enhanced virtual book devoted to the Disney movie Cars, provided according to one embodiment of the present invention.

### DETAILED DESCRIPTION OF THE INVENTION

The present application is directed to a method and system for providing enhanced virtual books. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

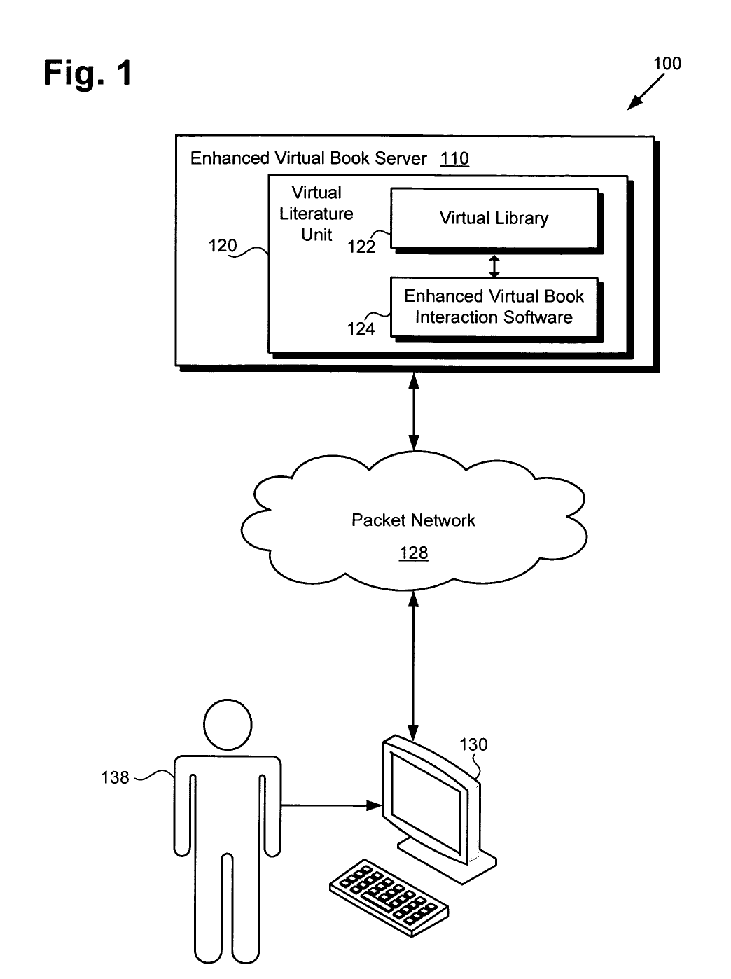

FIG. 1 shows a diagram of an exemplary system for providing enhanced virtual books, according to one embodiment of the present invention. In the embodiment of FIG. 1, system 100 comprises virtual literature unit 120, residing on enhanced virtual book server 110, and storing virtual library 122 and enhanced virtual book interaction software 124. Also shown in FIG. 1 are packet network 128, client computer 130, and user 138.

According to the embodiment of FIG. 1, user 138 may utilize client computer 130 and packet network 128 to access enhanced virtual book interaction software 124 in virtual literature unit 120. User 138 may then use virtual book interaction software 124 to browse virtual library 122, interact with its contents by previewing and/or selecting one or more enhanced virtual books stored in virtual library 122, and further interact with dynamic rich media content contained within each of those enhanced virtual books, for example. In effect, enhanced virtual book interaction software 124 enables user 138 to interact with electronically stored and delivered dynamic rich media content having the “look” and “feel” of a real book, thus capturing some of the aesthetic characteristics associated with enjoyment of a real book, but providing that experience in virtual form. It is noted that although client computer 130 is represented as a personal computer (PC) in FIG. 1, in other embodiments client computer 130 may be another type of personal communication device such as a mobile telephone, a digital media player, personal digital assistant (PDA), a wireless computer, or a gaming console, for example.

As shown in FIG. 1, enhanced virtual book interaction software 124, which may be an Extensible Markup Language (XML) based application, for example, can be accessed through packet network 128. In that instance, enhanced virtual book interaction software 124 may comprise a web application, accessible over a packet network such as the Internet. Alternatively, enhanced virtual book interaction software 124 may reside on a server supporting a local area network (LAN), for instance, or included in another type of limited distribution network. In another embodiment, virtual literature unit 120 containing virtual library 122 and enhanced virtual book interaction software 124, may comprise a high-definition computer readable storage medium such as a high-definition digital video disc (HD DVD), Blu-ray disc, or other high-definition optical disc, for example. Analogously, in another embodiment, virtual library 122 may reside on a server supporting a LAN or other limited distribution network.

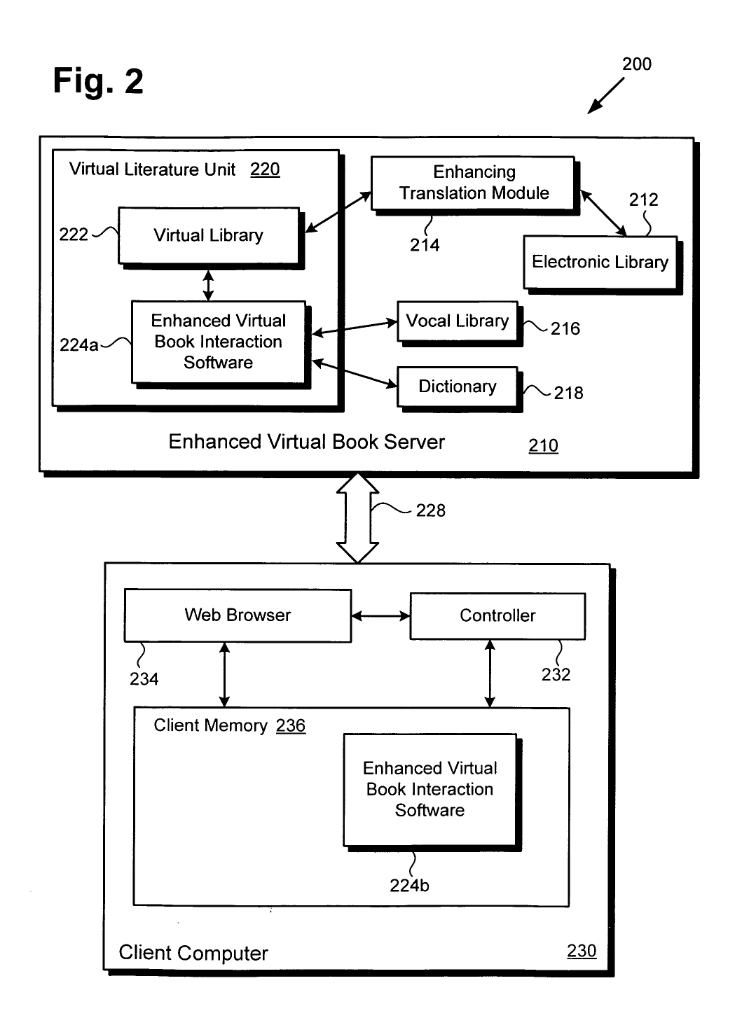

Turning now to FIG. 2, FIG. 2 provides a more detailed embodiment showing exemplary system 200 for providing enhanced virtual books. System 200, in FIG. 2, includes client computer 230 receiving a data transfer via communication link 228 from enhanced virtual book server 210. As may be seen from FIG. 2, enhanced virtual book server 210 includes virtual literature unit 220, which stores virtual library 222 and enhanced virtual book interaction software 224a. Also shown in FIG. 2 are electronic library 212, enhancing translation module 214, vocal library 216, and dictionary 218, all residing on enhanced virtual book server 210. Client computer 230 corresponds to client computer 130, in FIG. 1. As shown in FIG. 2, client computer 230 comprises controller 232, web browser 234, and client memory 236.

Enhanced virtual book server 210 and virtual literature unit 220, in FIG. 2, correspond respectively to enhanced virtual book server 110 and virtual literature unit 120, in FIG. 1. As shown in FIG. 2, virtual literature unit 220 includes virtual library 222 and enhanced virtual book interaction software 224a, corresponding to virtual library 122 and enhanced virtual book interaction software 124, in FIG. 1. Electronic library 212, enhancing translation module 214, vocal library 216, and dictionary 218 have no analogues appearing in FIG. 1. Although the embodiment of FIG. 2 shows vocal library 216 and dictionary 218 residing outside of virtual literature unit 220, that representation is exemplary only, and in another embodiment, vocal library 216 and dictionary 218 may reside in virtual literature unit 220. FIG. 2 further shows enhanced virtual book interaction software 214b, also not shown in FIG. 1.

In the present embodiment, interactive software application 214b is located in client memory 236, having been received from rich multimedia interaction host server 210 via communication link 216, and is used to facilitate access to the contents of virtual library 222. In another embodiment, however, enhanced virtual book interaction software 224b does not exist as a local asset of client computer 230. Instead, in that embodiment, enhanced virtual book interaction software 224a is a web application residing on enhanced virtual book server 210 and facilitating access to content stored available there.

Returning to the embodiment shown in FIG. 2 in which enhanced virtual book interaction software is imported to be a local asset, communication link 228 may represent download of enhanced virtual book interaction software 224a over a packet network, for example. In another embodiment, communication link 228 may represent transfer of enhanced virtual book interaction software 224a from a compact disc read-only memory (CD-ROM) or other portable computer readable storage medium. Once transferred, enhanced virtual book interaction software 224b may be stored in client memory 236 and run locally on client computer 230. It is noted that communication link 228 is shown as a two-way communication, to correspond to ongoing communication with virtual library 222, vocal library 216, and dictionary 218, residing on enhanced virtual book server 210.

Controller 232 may be the central processing unit for client computer 230, for example, in which role controller 232 runs the client computer operating system, launches web browser 234, and facilitates execution of enhanced virtual book interaction software 224b. Web browser 234, under the control of controller 232, may execute enhanced virtual book interaction software 224b to enable a user of client computer 230 to interact with on or more enhanced virtual books.

Implementation of system 200 enables provision of an enhanced virtual book to a user of client computer 230. In one embodiment, an electronic document corresponding to an electronic version of a book, such as a Portable Document Format (PDF) file version of a book, may be selected from electronic library 212 for conversion to an enhanced virtual book to be stored virtual library 222. Conversion may result from operation of enhancing translation module 214 configured to produce the enhanced virtual book from the electronic book selected from electronic library 212. Conversion may include translating a selected PDF file into a dynamic rich media format, such as a Flash movie, for example. Enhanced virtual book interaction software 224a or 224b, depending on whether the implementation supports online or local application, is configured to provide a user interface enabling a user of client computer 230 to navigate through the enhanced virtual book. As a result, the user may experience a virtual simulation of the experience of reading and enjoying a real book.

To further replicate the look and feel of the real experience, in one embodiment the enhanced virtual book may be displayed as a simulated three-dimensional scalable spread image of a book having turnable pages. For the purposes of the present application, a spread image is an image of an opened book, which shows both the respective left and right page leaves concurrently. Navigation through the enhanced virtual book may include advancing or retreating through the pages of the volume by manually turning the pages forward or backward, as with a real book, by means of a computer mouse, for example, clicking and holding a corner of the page and flipping or dragging to the next. The enhancements included in an enhanced virtual book may include enabling a user to hear the pronunciation of any of a plurality of words of text in the volume by reference to vocal library 216. In addition, enhancements may include enabling a user to learn the definition of any of a plurality of words of text in the virtual volume by reference to dictionary 218.

Moreover, in some embodiments, system 200 may provide special features associated with particular enhanced virtual books selected from virtual library 222. For example, an enhanced virtual book may include a special feature enabling the user of client computer 230 to go behind the page of a story to discover (i.e. see text or listen to audio describing) selected thoughts of one or more characters of the enhanced virtual book. Those selected thoughts may not be apparent within the text of the volume, but their accessibility may be indicated by changes in the appearance of a display cursor over a particular character. For example, the cursor may transform into a thought bubble over a character for which behind the page thoughts are available.

Another type of special feature may enable the user of client computer 230 to experience a page being brought to life by viewing a display that transitions from a sketch of the page, to a pencil drawing of the page and its characters, to the final full color page. By virtue of another special feature, the user of client computer 230 may participate in building a page of the enhanced virtual book by completing an unfinished illustration on the page, for example by coloring in a pencil drawing of the page. In yet another type of special feature, the user of client computer 230 may be encouraged to participate in the writing process by supplementing text appearing on one or more pages of the enhanced virtual book. That special feature may enable the user to produce alternative story lines, or alternative endings to existing story lines, for example.

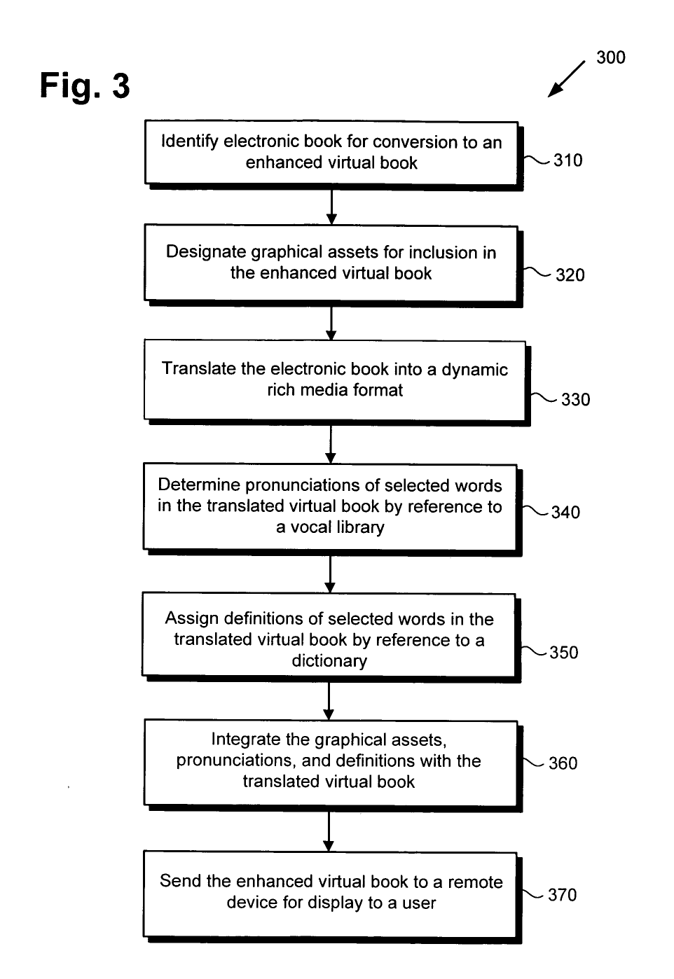

The present invention will now be further described by FIG. 3, which presents flowchart 300 describing an exemplary method of providing enhanced virtual books. Certain details and features have been left out of flowchart 300 that are apparent to a person of ordinary skill in the art. For example, a step may consist of one or more substeps or may involve specialized equipment or materials, as known in the art. While steps 310 through 370 in FIG. 3 are sufficient to describe a particular embodiment of the present method, other embodiments may utilize steps different from those shown in flowchart 300, or may include more, or fewer steps.

Continuing with step 310 of flowchart 300 and referring to FIG. 2, step 310 comprises identifying an electronic book for conversion to the enhanced virtual book. Step 310 may occur as the result of an automated comparison operation performed through enhancing translation module 214 in which the contents of electronic library 212 are compared to the contents of virtual library 222. Electronic books found to be present in electronic library 212, but not having corresponding enhanced virtual books stored in virtual library 222 may be identified for conversion on that basis, for example.

The exemplary method of flowchart 300 continues with step 320, which comprises designating graphical assets for inclusion in the enhanced virtual book. Designation of graphical assets in step 320 may correspond to determining the size and shape of a simulated three-dimensional scalable spread image of the enhanced virtual book to be provided. In one embodiment, the simulated three-dimensional scalable spread image of the enhanced virtual book includes turnable pages. In that embodiment, designation of graphical assets may include selection of appropriate visual cues to enable a reader to intuitively navigate through the enhanced virtual book by means of page turning. In addition, designation of graphical assets may include illumination of the text appearing in the enhanced virtual book by accompanying visual images. Such visual images may be designated on the basis of selection criteria applied in enhancing translation module 214, or in compliance with metadata contained by the electronic book undergoing conversion, for example.

In the embodiments described earlier in relation to FIG. 2, in which an enhanced virtual book offers special features such as allowing a user to go behind the page to discover selected thoughts of some of the characters by viewing text or hearing audio describing them, and/or bring a page to life by viewing transitions from sketch to pencil to color, and/or participating in the writing process, for example, step 320 may correspond to designation of appropriate graphical assets to support those special features. For example, going behind the page may require designation of appropriate visual transformation of a cursor in relation to character, perhaps by forming a thought bubble when hovering over the character, to cue a user that additional thought content may be accessed for that character.

Flowchart 300 continues with step 330, comprising translating the electronic book into a dynamic rich media format to produce a translated virtual book. In the embodiment of FIG. 2, translation is performed by enhancing translation module 214. Step 330 may correspond to translation of a PDF file identified in electronic library 212 in step 310, to Flash media format, for example.

Continuing with step 340 of flowchart 300 and FIG. 2, step 340 comprises determining pronunciations of selected words in the translated virtual book produced in step 330, by reference to vocal library 216. The selected words may form a plurality of the words included in the translated virtual book, and be determined according to data embedded by enhancing translation module 214. In one embodiment, the selected words may be determined dynamically by enhanced virtual book interaction software 224a or 224b. In any event, step 340 provides a user with the ability to designate a selected word 15 utilizing enhanced virtual book interaction software 224a or 224b, and listen to its corresponding spoken entry obtained from vocal library 216.

Step 350 of flowchart 300 comprises assigning definitions of selected words in the translated virtual book by reference to dictionary 218. As was the case for determination of selected pronunciations in step 340, in step 350 the selected words may form a plurality of the words included in the translated virtual book, and be determined according to data embedded by enhancing translation module 214, or be determined dynamically. In one embodiment, the plurality of words determined in step 340 and the plurality of words assigned in step 350 comprise the same plurality of words. In one embodiment, substantially all of the words displayed in the completed enhanced virtual book have their pronunciation determined by reference to vocal library 216, and have their definitions assigned by reference to dictionary 218.

Moving now to step 360 of flowchart 300, step 360 comprises integrating the graphical assets designated in step 330, the plurality of pronunciations determined in step 340, and the plurality of definitions assigned in step 350, with the translated virtual book produced in step 330, thereby providing the enhanced virtual book. The enhanced virtual book may then be stored in virtual library 222 and accessed by means of enhanced virtual book interaction software 224a or 224b. In subsequent step 370, the enhanced virtual book may be sent to a remote device, such as client computer 230 in FIG. 2, for display to a user. In one embodiment, the user may utilize controls local to client computer 230 to navigate through the provided enhanced virtual book. For example, the pages of an enhanced virtual book may be turned in response to commands received from the remote device, such as mouse commands from client computer 230.

It is noted that the remote device utilized by a user to view and navigate through the enhanced virtual book provided according to embodiments of the present invention may comprise a variety of personal communication devices, as previously described. As a result, a user may employ a corresponding variety of local commands, such as mouse commands, touch screen commands, keyboard commands, and the like, to access and navigate through an enhanced virtual book.

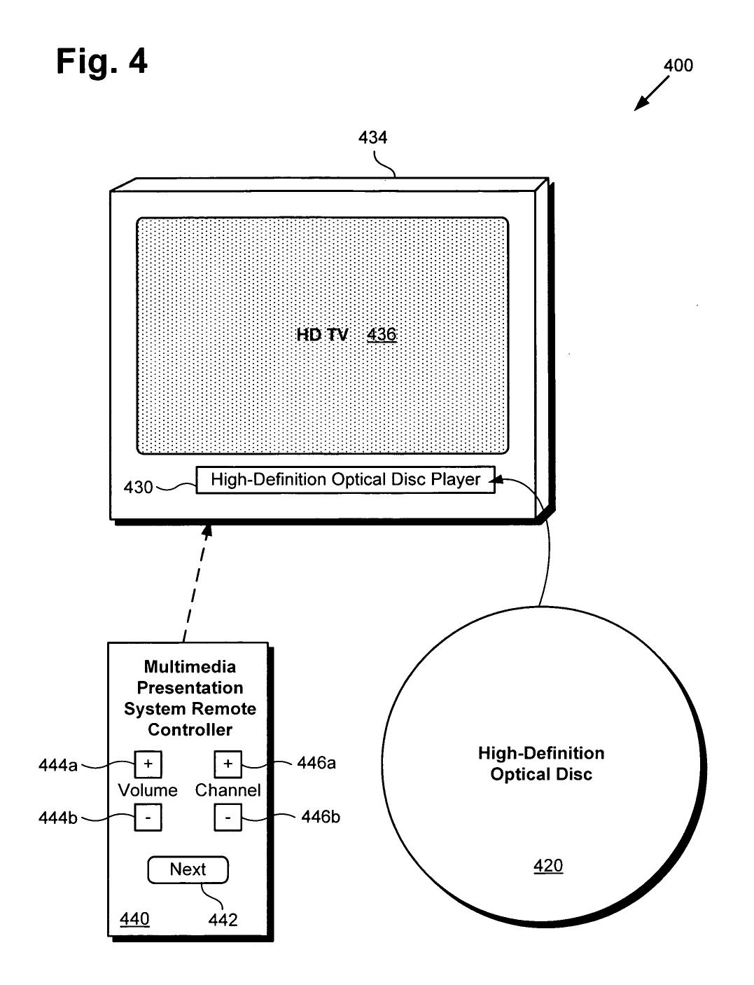

Turning now to FIG. 4, FIG. 4 shows a diagram of exemplary system 400 for providing enhanced virtual books stored on a computer readable medium, according to one embodiment of the present invention. FIG. 4 shows system 400 comprising high-definition optical disc 420, multimedia presentation system 434 including high-definition optical disc player 430 and high-definition television (HD TV) display 436, and multimedia presentation system remote controller 440. Also shown in FIG. 4, are multimedia presentation system remote controller features, including volume controls 444a and 444b, channel controls 446a and 446b, and “next” button 114.

High-definition optical disc 420, which may correspond to virtual literature unit 220, in FIG. 2, may be a Blu-ray disc or HD DVD, for example containing a plurality of high-definition dynamic rich media segments corresponding respectively to enhanced virtual books. In addition, high-definition optical disc 420 may store instructions comprising an enhanced virtual book interaction software, corresponding to enhanced virtual book interaction software 224a, in FIG. 2, which, when executed by high-definition optical disc player 430, cause a selected enhanced virtual book to be displayed on HD TV display 436. It is noted that although the embodiment of FIG. 4 describes storage of enhanced virtual books and enhanced virtual book interaction software on high-definition optical disc 420, more generally those contents may reside on any computer readable medium suitable for storage of high-definition dynamic rich media content.

According to the embodiment of FIG. 4, a user of multimedia presentation system 434 may utilize high-definition optical disc player 430 and HD TV display 436 to view the contents of a virtual library stored on high-definition optical disc 420, select an enhanced virtual book from that library, and read the enhanced virtual book. Moreover, a user may utilize multimedia presentation system remote controller 440 to navigate through the book, for example by depressing next button 442 to execute a highlighted onscreen command, or to advance or retreat through the turnable pages of an enhanced virtual book. In one embodiment, high-definition optical disc 420 may also have stored thereon a vocal library, and/or dictionary (not shown in FIG. 4), corresponding respectively to vocal library 216 and dictionary 218, in FIG. 2.

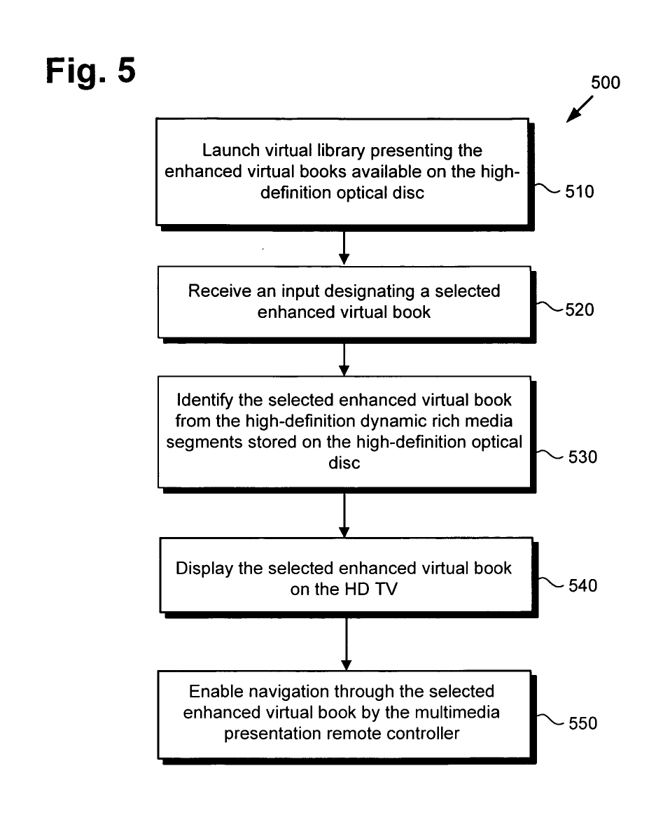

The use and operation of system 400 will be further described by reference to FIG. 5, which presents flowchart 500 of a method of providing enhanced virtual books stored on a computer readable medium, according to on embodiment of the present invention. Certain details and features have been left out of flowchart 500 that are apparent to a person of ordinary skill in the art. For example, a step may comprise one or more substeps or may involve specialized equipment or materials, as known in the art. While steps 510 through 550 indicated in flowchart 500 are sufficient to describe one embodiment of the present method, other embodiments may utilize steps different from those shown in flowchart 500, or may include more, or fewer steps.

Step 510 of flowchart 500 comprises launching a virtual library presenting the enhanced virtual books available on high-definition optical disc 420. Step 510 may occur, for example, under the direction of an enhanced virtual book interaction software activated by insertion of high-definition optical disc 420 in to high-definition optical disc player 430 by a user. Launching the virtual library stored on high-definition optical disc 420 enables a user to view the contents of high-definition optical disc 420 and select an available enhanced virtual book for viewing.

Continuing with step 520 of flowchart 500, step 520 comprises receiving an input designating a selected enhanced virtual book. A user of multimedia presentation system 434 may designate a selected enhanced virtual book from the virtual library displayed as a result of step 510, by highlighting an icon corresponding to that item of high-definition dynamic rich media content appearing on HD TV display 436, for example. A selection made by means of controls on high-definition optical disc player 430, or multimedia presentation system remote controller 440 can cause the designating input to be received by the enhanced virtual book interaction software active on high-definition optical disc player 430.

In step 530, the enhanced virtual book interaction software identifies the selected enhanced virtual book from among the high-definition dynamic rich media segments stored on high-definition optical disc 420. In one embodiment, high-definition optical disc 420 may comprise ten high-definition dynamic rich media segments corresponding to ten distinct enhanced virtual books available for reading by a user of multimedia presentation system 434, for example. Following identification of the appropriate high-definition dynamic rich media segment in step 530, the selected enhanced virtual book may be displayed in step 540. Display of the selected enhanced virtual book may comprise presentation of a Flash movie including a simulated three-dimensional, scaled, spread image of the enhanced virtual book having turnable pages, for example.

Moving on to step 550 of flowchart 500, step 550 comprises enabling navigation through the selected enhanced virtual book by multimedia presentation system remote controller 440. Step 550 corresponds to allowing a user to turn the pages of the enhanced virtual book, activate any enhancements or special features available with the enhanced virtual book, as described previously, and interact with those enhancements and special features, by means of multimedia presentation system remote controller 440. For example, volume controls 444a and 444b may be utilized to regulate an audio narrative included in the enhanced virtual book, or increase or reduce the loudness of pronunciations provided by a vocal library. In one embodiment, next button 442 may be depressed to execute a page turning command, while channel controls 446a and 446b may be utilized to navigate forward or back through the book a chapter at a time, rather than a page at a time.

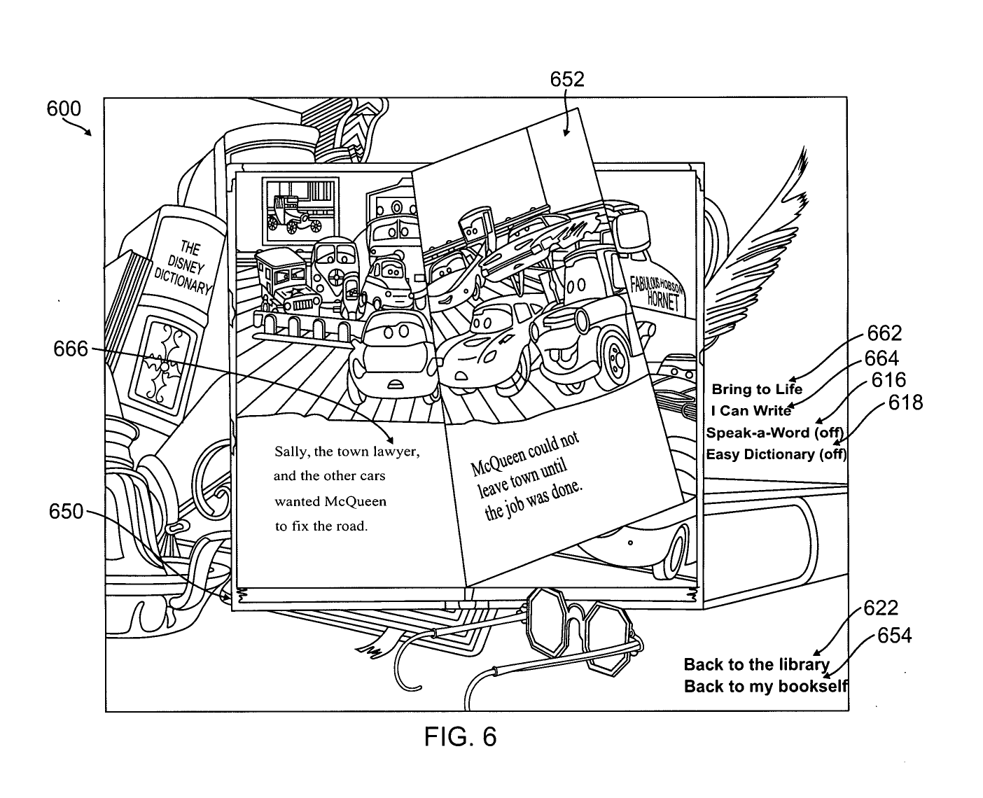

Turning now to FIG. 6, FIG. 6 shows visual frame 600 of exemplary enhanced virtual book 650 devoted to the Disney movie Cars, provided according to one embodiment of the present invention. Enhanced virtual book 650 shown in visual frame 600 may be presented as a Flash movie, for example. As may be understood from FIG. 6, enhanced virtual book 650 is displayed as a simulated three-dimensional image, scaled to simulate a real book. The pages of enhanced virtual book 650, represented by page 652, are turnable, so that a user can navigate forward or backward through enhanced virtual book 650 by entering appropriate commands, for example by a computer mouse connected to client computer 230 the system of FIG. 2, or by means of inputs to multimedia presentation system remoter controller 440, in FIG. 4.

Also shown in visual frame 600 are command links enabling a user to navigate away from enhanced virtual book 650 by selecting the “back to the library” option 622, or going back to the user's bookshelf through option 654. In some embodiments, such as the embodiment of FIG. 4, the library and user bookshelf may comprise substantially the same content, in which case one or the other option may not be shown. In other embodiments, however, such as the online version of the system for providing enhanced virtual books described in relation to FIG. 2, a user may purchase or rent enhanced virtual books from virtual library 222, and have the selected subset of virtual library 222 copied from that location to a user bookshelf stored either on enhanced virtual book server 210, or on client computer 230.

Additional features of enhanced virtual book 650 are shown by speak-a-word feature 616 and easy dictionary feature 618. As may be seen from FIG. 6, in the instantiation of enhanced virtual book 650 captured by visual frame 600, both speak-a-word feature 616 and easy dictionary feature 618 are turned off. Either or both features may be activated by inputs provided from a user, through a computer mouse click, touch screen contact, or keyboard or remote controller command, for example. Once activated, a subsequent user input selection of a word of text, such as the word “lawyer” 666, would result in pronunciation of the word and/or display of the word meaning, according to corresponding respective entries in vocal library 216 and dictionary 218, shown in FIG. 2.

Special features available to a reader of enhanced virtual book 650 are shown in FIG. 6 by “bring to life” feature 662 and “I can write” feature 664. As previously described, “bring to life” feature 662 corresponds to enabling the user to experience page 652 and its facing page being brought to life by viewing a display that transitions from a sketch of the pages, to a pencil drawing of the pages and its characters, to the final full color display. Also as previously described, “I can write” feature 664 corresponds to encouraging the user to participate in the writing process by supplementing text appearing on page 652 or its facing page. Other embodiments may include additional special features to enhance the reading experience and encourage a user to interact with enhanced virtual book 650. FIG. 6, while by no means providing a comprehensive picture of enhanced virtual books, reveals some of the variety, complexity, and contextual relevance achieved by the embodiments disclosed herein.

Thus, the present application discloses a method and system for providing virtual enhanced books. By translating an electronic book into a dynamic rich media format having integrated graphical assets, the present disclosure describes a virtual book that simulates many of the aesthetically pleasing characteristics of a real book. By enhancing the virtual book with features providing guidance to the correct pronunciation and meaning of words appearing in the virtual book, one disclosed embodiment empowers a user by providing access to learning tools. By further offering special features enabling a user to interact with and engage the creative processes of producing literary or graphical content, various embodiments disclosed in the present application encourage a user to seek out new content, to learn, and to create. Thus, the present disclosure describes a method and system providing information content in a form that preserves the experience of enjoying books, while concurrently delivering the efficiencies and advantages available from modem electronic documents.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. It should also be understood that the invention is not limited to the particular embodiments described herein, but is capable of many rearrangements, modifications, and substitutions without departing from the scope of the invention.

What is claimed is:

1. A method of providing a virtual book, the method comprising:
identifying an electronic book for conversion to the virtual book;
designating graphical assets for inclusion in the virtual book;
translating the electronic book into a dynamic rich media format to produce a translated virtual book;
determining a plurality of pronunciations by associating each of a first plurality of words in the translated virtual book with its respective entry in a vocal library;
assigning a plurality of definitions by associating each of a second plurality of words in the translated virtual book with its respective entry in a dictionary; and
integrating the graphical assets, the plurality of pronunciations, and the plurality of definitions with the translated virtual book to generate the virtual book.

2. The method of claim 1, wherein designating graphical assets includes determination of a simulated three-dimensional scalable spread image of the virtual book, the simulated three-dimensional scalable spread image of the virtual book having turnable pages.

3. The method of claim 1, wherein the electronic book comprises a Portable Document Format (PDF) file.

4. The method of claim 1, wherein the virtual book comprises a Flash movie.

5. The method of claim 1, wherein the first plurality of words and the second plurality of words substantially equal one another, and comprise substantially all words displayed in the virtual book.

6. The method of claim 1, further comprising enabling display of the virtual book on a remote device.

7. The method of claim 6, wherein the remote device comprises a personal communication device selected from the group consisting of a mobile telephone, a digital media player, personal digital assistant (PDA), a wired or wireless computer, and a gaming console.

8. The method of claim 6, further comprising making pages of the virtual book turnable in response to commands received from a user of the remote device.

9. The method of claim 8, further comprising enabling the user of the remote device to go behind the page of a story to discover selected thoughts of one or more characters of the virtual book.

10. The method of claim 8, further comprising enabling the user of the remote device to experience a page being brought to life by viewing a display that transitions from a sketch of the page, to a pencil drawing of the page and its characters, to the final full color page.

11. The method of claim 8, further comprising enabling the user of the remote device to participate in building a page of the virtual book by completing an unfinished illustration on the page.

12. The method of claim 8, further comprising encouraging the user of the remote device to participate in a writing process by supplementing text appearing on one or more pages of the virtual book.

13. A system for providing a virtual book, the system comprising:
a virtual book server;
an enhancing translation module residing on the virtual book server, the enhancing translation module configured to produce the virtual book from an electronic book selected from an electronic library;
a virtual library stored on a virtual literature unit, the virtual library configured to store the virtual book produced by the enhancing translation module; and
a virtual book interaction software stored on the virtual literature unit, the virtual book interaction software configured to provide a user interface enabling navigation through the virtual book;
the system being capable of enabling selection of the virtual book from the virtual library, display of the virtual book on a remote device, and navigation through the virtual book by a user of the remote device.

14. The system of claim 13, wherein the electronic book comprises a Portable Document Format (PDF) file.

15. The system of claim 13, wherein the virtual book comprises a Flash movie.

16. The system of claim 13, wherein pages of the virtual book are turnable in response to commands received from the user of the remote device.

17. The system of claim 13, wherein the virtual book enables the user of the remote device to go behind the page of a story to discover selected thoughts of one or more characters of the virtual book.

18. The system of claim 13, wherein the virtual book enables the user of the remote device to experience a page being brought to life by viewing a display that transitions from a sketch of the page, to a pencil drawing of the page and its characters, to the final full color page.

19. The system of claim 13, wherein the virtual book enables the user of the remote device to participate in building a page of the virtual book by completing an unfinished illustration on the page.

20. The system of claim 13, wherein the virtual book enables the user of the remote device to participate in a writing process by supplementing text appearing on one or more pages of the virtual book.

21. The method of claim 13, wherein the remote device comprises a personal communication device selected from the group consisting of a mobile telephone, a digital media player, personal digital assistant (PDA), a wired or wireless computer, and a gaming console.

22. A computer readable medium having stored thereon a plurality of high-definition dynamic rich media segments corresponding to a plurality of virtual books, and instructions comprising a virtual book interaction software which, when executed by a multimedia presentation system, perform a method comprising:
launching a virtual library presenting the plurality of virtual books available on the computer readable medium;
receiving an input from said multimedia presentation system designating the selected virtual book from among the plurality of virtual books;
identifying the selected virtual book from the plurality of high-definition dynamic rich media segments stored on the computer readable medium;
displaying the selected virtual book on the multimedia presentation system; and
enabling navigation through the selected virtual book by one or more controls of the multimedia presentation system.

23. The computer readable medium of claim 22, wherein the computer readable medium comprises a Blu-ray disc.

24. The computer readable medium of claim 22, wherein the computer readable medium comprises a high-definition digital video disc (HD DVD).

25. The computer readable medium of claim 22, wherein the multimedia presentation system comprises a high-definition television (HD TV).

26. The computer readable medium of claim 22, wherein enabling navigation through the selected virtual book by one or more controls of the multimedia presentation system comprises enabling a user of a remote controller of the multimedia presentation system to turn pages of the virtual book by the remote controller.

27. A method for use by a virtual book interaction software for execution by a multimedia presentation system, the method comprising:
launching a virtual library presenting the plurality of virtual books available on the computer readable medium;
receiving an input from said multimedia presentation system designating the selected virtual book from among the plurality of virtual books;
identifying the selected virtual book from the plurality of high-definition dynamic rich media segments stored on the computer readable medium;
displaying the selected virtual book on the multimedia presentation system; and
enabling navigation through the selected virtual book by one or more controls of the multimedia presentation system.

28. The method of claim 27, wherein the virtual book interaction software runs a Blu-ray disc, and the multimedia presentation system includes a Blu-ray disc.

29. The method of claim 27, wherein enabling navigation through the selected virtual book by one or more controls of the multimedia presentation system comprises enabling a user of a remote controller of the multimedia presentation system to turn pages of the virtual book by the remote controller.
